(19) United States
(12) Patent Application Publication
(10) Pub. No.: US 2013/0044270 A1
(43) Pub. Date: Feb. 21, 2013

(54) LIQUID CRYSTAL DISPLAY DEVICE AND METHOD OF MANUFACTURING THE SAME

(71) Applicants: Takeo Koito, Kanagawa (JP); Daisuke Takama, Kanagawa (JP); Morikazu Nomura, Aichi (JP)

(72) Inventors: Takeo Koito, Kanagawa (JP); Daisuke Takama, Kanagawa (JP); Morikazu Nomura, Aichi (JP)

(73) Assignee: Japan Display West Inc., Higashiura-Cho (JP)

(21) Appl. No.: 13/565,143

(22) Filed: Aug. 2, 2012

(30) Foreign Application Priority Data
Aug. 17, 2011 (JP) 2011-178210

(51) Int. Cl. G02F 1/1333; G02F 1/1339

(52) U.S. Cl. 349/58; 349/190

(57) ABSTRACT

A liquid crystal display device includes: a display section including a liquid crystal layer between a pair of substrates; and a frame edge section provided to a periphery section of the pair of substrates. The frame edge section includes an injection port and an injection port section, the injection port being for injection of a liquid crystal material, and the injection port section being provided between the injection port and the display section. The injection port section includes a barrier structure including a clearance, and the barrier structure being in contact with both of the pair of substrates, and a sealing material filled in a portion extending from the injection port to the barrier structure.

### BACKGROUND

The present disclosure relates to a liquid crystal display device suitable for reduction of frame width, and to a method of manufacturing the same.

With a liquid crystal display device, a display section is provided therearound with a sealing frame, and a liquid crystal material is injected from an injection port formed thereto for injection. After the completion of injection, the injection port is closed by being filled with a sealing material. With the previous technology, for example, a barrier is provided in the vicinity of the injection port to partially block the path for the sealing material, thereby making an attempt to reduce leakage of the sealing material to the display region (for example, see Japanese Unexamined Patent Application Publication No. 2010-44136, and for reference, see Japanese Unexamined Patent Application Publication No. 2008-241752).

### SUMMARY

With such a previous technology, the barrier provided in the vicinity of the injection port indeed reduces the injection speed of the sealing material. However, at the time of injection of the sealing material through adjustment of a cell gap, the clearance is easily changed in size whenever the liquid crystal material and the sealing material flow therethrough. As a result, the injection speed of the sealing material greatly varies, thereby disadvantageously causing changes in the injection amount of the sealing material, i.e., sometimes too much but sometimes not enough. Specifically when the frame around the display region is narrow, the injection amount of the sealing material is expected to be controlled with a good precision, and there thus is a demand for reducing the variations in injection speed of the sealing material.

It is thus desirable to provide a liquid crystal display device capable of reducing the variations in injection speed and amount of a sealing material, and a method of manufacturing the same.

According to an embodiment of the present disclosure, there is provided a liquid crystal display device including: a display section including a liquid crystal layer between a pair of substrates; and a frame edge section provided to a periphery section of the pair of substrates. The frame edge section includes an injection port and an injection port section, the injection port being for injection of a liquid crystal material, and the injection port section being provided between the injection port and the display section. The injection port section includes a barrier structure including a clearance, and the barrier structure being in contact with both of the pair of substrates, and a sealing material filled in a portion extending from the injection port to the barrier structure.

With the liquid crystal display device according to the embodiment, the liquid crystal material is injected into the display section after passing through the clearance of the barrier structure provided to the injection port section, but the sealing material stops at the clearance of the barrier structure, thereby reducing the leakage thereof to the display section. Unlike the previous technology of providing the barrier in the vicinity of the injection port, this eliminates the possibility of size change of the clearance in the manufacturing processes. Accordingly, the injection speed and amount of the sealing material vary less.

According to an embodiment of the present disclosure, there is provided a method of manufacturing a liquid crystal display device, the liquid crystal display device including a display section including a liquid crystal layer between a pair of substrates, and a frame edge section provided to a periphery section of the pair of substrates, and the frame edge section including an injection port and an injection port section, the injection port being for injection of a liquid crystal material, and the injection port section being provided between the injection port and the display section. The method includes: forming a barrier structure to the injection port section, and the barrier structure including a clearance and being in contact with both of the pair of substrates; and filling a sealing material in a portion extending from the injection port to the barrier structure.

With the liquid crystal display device according to the embodiment of the present disclosure, or with the method of manufacturing the liquid crystal display device according to the embodiment of the present disclosure, the injection port section is formed with the barrier structure so that the injection speed and amount of the sealing material vary less.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a top view showing the configuration of a liquid crystal display device according to a first embodiment of the present disclosure.

FIG. 2 is an enlarged top view of a part of the liquid crystal display device of FIG. 1.

FIG. 3 is a cross-sectional view of the part of FIG. 2 cut along a line III-III.

FIG. 4 is a perspective diagram showing the configuration of a barrier structure of FIG. 3.

FIG. 5 is a top view for illustrating the state of a sealing material stopped moving in a clearance of FIG. 4.

FIG. 6 is a cross-sectional diagram for illustrating disadvantages of a previous barrier.

FIG. 7A is a top view showing the configuration of the barrier structure of a liquid crystal display device according to a modification example 1 in which a protrusion with an inclined section is provided at the outlet of the clearance, and FIG. 7B is a top view for illustrating the state of the sealing material sliding in the clearance of FIG. 5.

FIG. 8 is a cross-sectional diagram showing the configuration of the barrier structure of a liquid crystal display device according to a modification example 2.

FIG. 9 is a cross-sectional diagram showing the configuration of the barrier structure of a liquid crystal display device according to a modification example 3.

(A) of FIG. 10 is a diagram showing the measurement results of a difference of draw-in degree of the sealing material between with or without the barrier structure, and (B) of FIG. 10 is a cross-sectional diagram showing the configuration of the barrier structure used for the measurement.

FIG. 11 is a top view showing the configuration of the barrier structure of a liquid crystal display device according to a modification example 4.

FIG. 12 is a top view showing the shape of the clearance of FIG. 2.

FIG. 13 is a top view showing the configuration of the barrier structure of a liquid crystal display device according to a modification example 5.

FIG. 14 is an enlarged top view showing a part of a liquid crystal display device according to a modification example 6.

FIG. 15 is a cross-sectional view of the part of FIG. 14 cut along a line XV-XV.

FIG. 16 is a cross-sectional diagram showing the configuration of the barrier structure of a liquid crystal display device according to a modification example 7.

FIG. 17 is a cross-sectional diagram showing the configuration of the barrier structure of a liquid crystal display device according to a modification example 8.

FIG. 18 is a cross-sectional diagram showing the configuration of the barrier structure of a liquid crystal display device according to a modification example 9.

FIG. 19 is a perspective diagram showing the configuration of the barrier structure of FIG. 18.

FIG. 20 is a cross-sectional diagram showing the configuration of the barrier structure of a liquid crystal display device according to a modification example 10.

FIG. 21 is a perspective diagram showing the configuration of the barrier structure of FIG. 20.

FIGS. 22A to 22C are cross-sectional diagrams showing, in order, the main part of a method of manufacturing the liquid crystal display device of FIG. 20.

FIG. 23 is a perspective diagram showing a process subsequent to the process of FIG. 22C.

FIGS. 24A and 24B are cross-sectional diagrams showing processes subsequent to the process of FIG. 23.

FIG. 25 is an enlarged plan view showing a part of a liquid crystal display device according to a modification example 11.

FIG. 26 is a cross-sectional diagram showing the configuration of the part of FIG. 25 cut along a line XXVI-XXVI.

FIG. 27 is a perspective diagram showing the configuration of the barrier structure of FIG. 26.

FIGS. 28A and 28B are cross-sectional diagrams each showing the configuration of the barrier structure of a liquid crystal display device according to a modification example 12.

FIG. 29 is a cross-sectional diagram showing the configuration of the barrier structure of a liquid crystal display device according to a modification example 13.

FIGS. 30A to 30C are cross-sectional diagrams showing, in order, the main part of a method of manufacturing the liquid crystal display device of FIG. 29.

FIGS. 31A and 31B are cross-sectional diagrams showing processes subsequent to the process of FIG. 30C.

FIG. 32 is a perspective diagram showing an example of reducing the size of the clearance more than the gap of a display section in the barrier structure of FIG. 29.

FIG. 33 is a perspective diagram showing an example of increasing the size of the clearance more than the gap of the display section.

FIG. 34 is an enlarged plan view showing a part of a liquid crystal display device according to a second embodiment of the present disclosure.

FIG. 35 is a cross-sectional view of the part of FIG. 34 cut along a line XXXV-XXXV.

FIG. 36 is a perspective view showing the configuration of the barrier structure of FIG. 34.

FIG. 37 is a plan view showing the configuration of the barrier structure of a liquid crystal display device according to a modification example 14.

FIG. 38 is a plan view showing the configuration of the barrier structure of a liquid crystal display device according to a modification example 15.

### DETAILED DESCRIPTION OF THE PREFERRED EMBODIMENTS

In the below, embodiments of the present disclosure are described in detail by referring to the accompanying drawings. Note that the description is given in the following order.

1. First Embodiment (Exemplary barrier structure with a plurality of pillars above a wall)

2. Modification Example 1 (Example with a protrusion having an inclined section at the outlet of a clearance)

3. Modification Example 2 (Example with a plurality of pillars beneath the wall)

4. Modification Example 3 (Exemplary barrier structure with a plurality of pillars between upper and lower walls)

5. Modification Example 4 (Example with a clearance provided obliquely to the direction from which a sealing material comes)

6. Modification Example 5 (Example with a meander-shaped clearance)

7. Modification Example 6 (Example with a dual set of barrier structures)

8. Modification Example 7 (Example with a plurality of pillars configured by the same layer as a spacer layer of a display section)

9. Modification Example 8 (Example with a plurality of pillars configured by the same layer as an overcoat layer)

10. Modification Example 9 (Example with a wall configured by the same layer as the spacer layer of the display section, and a plurality of pillars configured by the same layer as an organic insulating layer being a planarizing layer)

11. Modification Example 10 (Example of configuring a concave section by removing the organic insulating layer around the barrier structure)

12. Modification Example 11 (Example of providing a base layer beneath the organic insulating layer to make uneven the surface thereof for use as a plurality of pillars)

13. Modification Example 12 (Example of adjusting the gap using existing layers such as a metal wiring layer, a color filter, and a light-shielding film)

14. Modification Example 13 (Example of configuring the upper wall using a gap adjusting layer of the semi-transmissive display section)

15. Second Embodiment (Example in which the barrier structure includes a plurality of walls provided not to be vertical to the direction from which the sealing material comes)

16. Modification Example 14 (Example of providing an injection port at the middle position on one side of the display section, and the barrier structure linearly along the contour of the display section)

17. Modification Example 15 (Example of providing the injection port at one corner of the display section, and the barrier structure in the L shape along the contour of the display section)

### First Embodiment

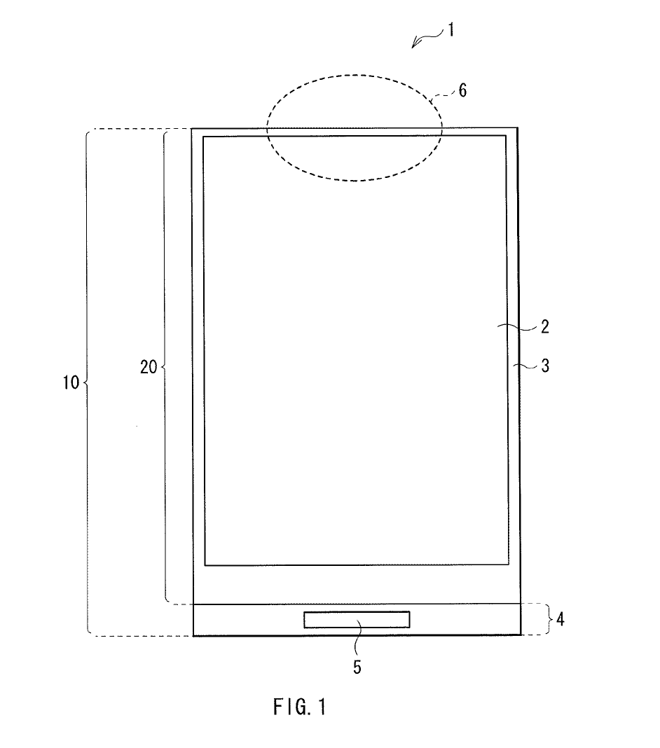

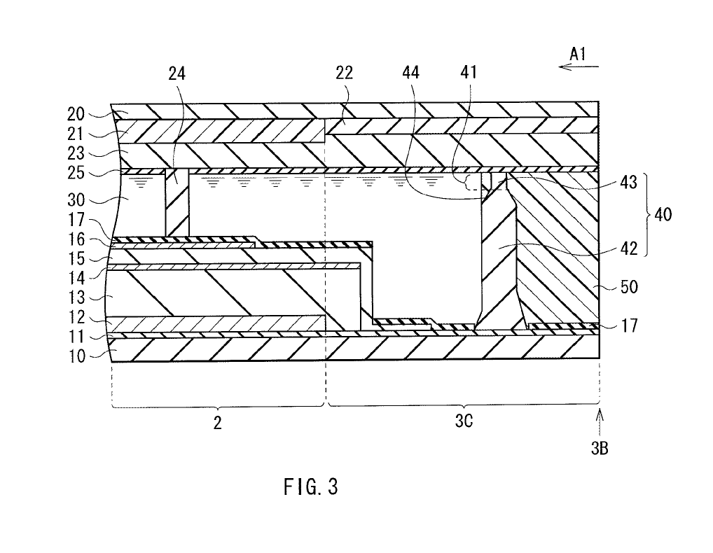

FIG. 1 is a diagram showing the entire configuration of a liquid crystal display device according to a first embodiment of the present disclosure. This liquid crystal display device 1 is used for a mobile phone or a smartphone, for example, and includes a display section 2, and a frame edge section 3 around the display section 2. The display section 2 includes a liquid crystal layer 30 between a pair of substrates (first and second substrates 10 and 20) each made of glass, for example (not shown in FIG. 1, and see FIG. 3). The display section 2 includes a plurality of pixels (not shown) each being a liquid crystal display element, and being arranged in a matrix. The frame edge section 3 is a region on the periphery of the first and second substrates 10 and 20, and the internal configuration thereof is shielded by a light-shielding film 22 in black (not shown in FIG. 1, and see FIG. 3).

On one side of the first substrate 1, provided is an exposed region 4 being a region out of the second substrate 20. This exposed region 4 is provided with an external connection terminal 5 by the wiring extending from a signal line drive circuit and a scan line drive circuit (neither are shown) on the first substrate 10.

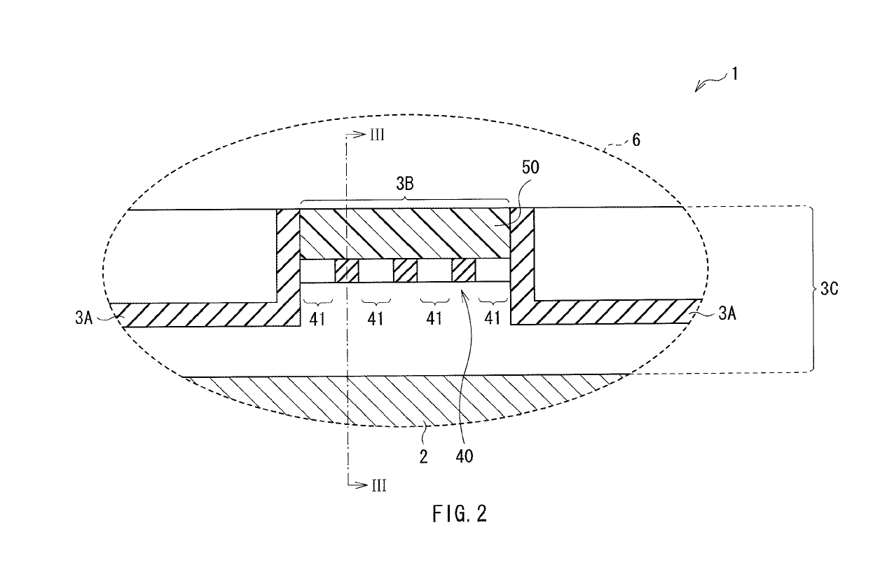

FIG. 2 is an enlarged view of a part enclosed by a dotted line 6 in the liquid crystal display device 1 of FIG. 1. FIG. 3 is a diagram showing the cross-sectional configuration of the part of FIG. 2 cut along a line III-III. The frame edge section 3 is provided with a sealing frame 3A to enclose the display section 2. The sealing frame 3A is made of a thermosetting resin or an ultraviolet curable resin, for example. The sealing frame 3A is provided with an injection port 3B for injection of a liquid crystal material. The portion between the injection port 3B and the display section 2 is an injection port section 3C serving as a path through which the liquid crystal material and a sealing material come. The injection port section 3C is provided with a barrier structure 40, and includes a sealing material 50. The barrier structure 40 has clearances 41 to allow the liquid crystal material to pass therethrough, and is in contact with both the first and second substrates 10 and 20. The sealing material 50 is filled in the portion extending from the injection port 3B to the barrier structure 40. With the liquid crystal display device 1 configured as such, variation of the injection speed and amount of the sealing material 50 is allowed to be reduced.

As exemplarily shown in FIG. 4, the barrier structure 40 includes a wall 42, and a plurality of pillars 43. The wall 42 extends, on the first substrate 10, in a direction intersecting with a direction A1 from which the sealing material 50 comes (for example, in the vertical direction). The pillars 43 are disposed between the upper surface of the wall 42 and the second substrate 20. The liquid crystal material is directed to the display section 2 by passing through the clearances 41 between the pillars 43. Through adjustment of the height and width of the clearances 41, the sealing material 50 is controlled in injection speed and amount. The material of the barrier structure 40 is not specifically restrictive, and may be an insulating material or metal, for example.

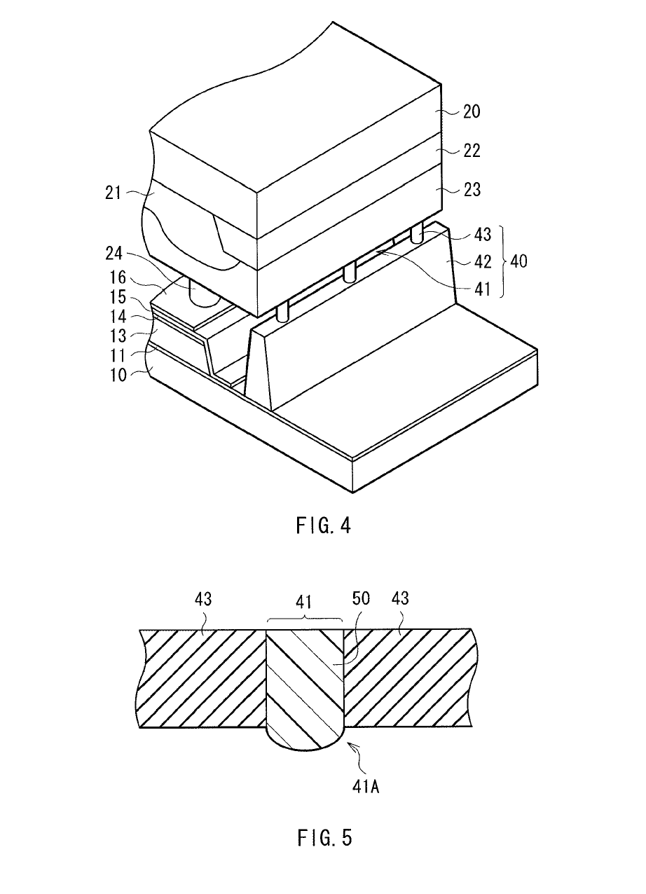

The sealing material 50 is for blocking the injection port section 3C to seal the liquid crystal material in the display section 2, and is an ultraviolet curable resin, for example. The sealing material 50 is filled up in the injection port section 3C to the position away by about 50 μm from the injection port 3B for inhibiting infiltration of fluid, for example. As exemplarily shown in FIG. 5, the sealing material 50 is stopped at an outlet 41A of the clearance 41 between the pillars 43 due to the interfacial force. This interfacial force is dependent on the liquid crystal material, the sealing material 50, and the material of the barrier structure 40. This means that the sealing material 50 is to be controlled by increasing the interfacial force through material selections.

The first substrate 10 of the display section 2 is provided with an insulating layer 11, a metal wiring layer 12, an organic insulating layer 13 being a planarizing layer, a common electrode 14, an inter-layer insulating film 15, a pixel electrode 16, and an orientation film 17, for example. These components are provided in this order from the first substrate 10 side. In other words, this display section 2 is in the so-called FFS (Fringe Field Switching) structure. Herein, the insulating layer 11 is provided between gate lines and signal lines irrespective of liquid crystal mode.

The second substrate 20 of the display section 2 is provided with a color filter 21, a light-shielding film 22 being a black matrix, an overcoat layer 23 being a planarizing layer, a spacer layer 24, and an orientation film 25, for example. These components are provided in this order from the second substrate 20 side. Between the first and second substrates 10 and 20, the liquid crystal layer 30 is provided. Note that the first and second substrates 10 and 20 are each affixed on the outside with a polarizing plate (not shown), for example. On the rear surface side of the first substrate 10, a backlight unit (not shown) such as a light source and a light-guiding plate is provided, for example.

This liquid crystal display device is manufactured as below, for example.

First of all, the first substrate 10 made of glass or others is made ready, and a drive circuit (not shown) being a TFT (Thin Film Transistor) or others, and the metal wiring layer 12 are formed on this first substrate 10. Thereafter, the drive circuit and the metal wiring layer 12 are covered by the organic insulating layer 13, thereby planarizing the surface of the display section 2. Next, the common electrode 14, the inter-layer insulating film 15, and the pixel electrode 16 are formed in order on the organic insulating layer 13.

The second substrate 20 made of glass or others is then made ready, and the color filter 21, and the light-shielding film 22 are formed on this second substrate 20. Next, the color filter 21 and the light-shielding film 22 are coated by the overcoat layer 23 so as to planarize the surface asperities resulted from the thickness difference between colors of the color filter 21. Next, in the display section 2, the spacer layer 24 is formed.

Thereafter, to the frame edge section 3 of the first substrate 10, for example, the sealing frame 3A is formed using a thermosetting resin or an ultraviolet curable resin. The sealing frame 3A is formed in the rectangular frame shape to enclose the display section 2, and is provided with the injection port 3B on one side of the first substrate 10. Between the injection port 3B and the display section 2, the injection port section 3C is provided. Next, the barrier structure including the wall 42, and the pillars 43, for example, are formed in the injection port section 3C. For forming the barrier structure 40 as such, the barrier structure 40 may be entirely formed to either the first or second substrate 10 or 20, or may be in the multi-layer structure with a plurality of layers for allocation to the first and second substrates 10 and 20. The latter structure is described later in detail in modification examples 7 to 13.

Thereafter, the orientation film 17 is formed in the display section 2 of the first substrate 10, and the orientation film 25 is formed in the display section 2 of the second substrate 20. Next, the first and second substrates 10 and 20 are opposed to each other with the sealing frame 3A sandwiched therebetween. The resin configuring the sealing frame 3A is then cured, thereby affixing together the first and second substrates 10 and 20.

Thereafter, a liquid crystal material is filled into the internal space between the first and second substrates 10 and 20. The liquid crystal material is directed to the display section 2 after passing through the clearances 41 between the pillars 43 of the barrier structure 40.

Thereafter, under a reduced pressure inside the sealing frame 3A, the sealing material 50 is applied around the injection port 3B, thereby directing the sealing material 50 into the injection port section 3C. As exemplarily shown in FIG. 5, the sealing material 50 stops moving at the outlet 41A of the clearances 41 each between the pillars 43 due to the interfacial force described above. As a result, the sealing material 50 is filled in the portion from the injection port 3B to the barrier structure 40 so that the leakage thereof to the display section 2 is reduced.

In this example, since the barrier structure 40 is in contact with both the first and second substrates 10 and 20, the clearances 41 are not changed in size every time the sealing material 50 is injected. Therefore, the injection speed, time, and amount of the sealing material 50 vary less. Moreover, a possibility of injection failure of the liquid crystal material is reduced. In this manner described above, the liquid crystal display device 1 of FIGS. 1 to 5 is completed.

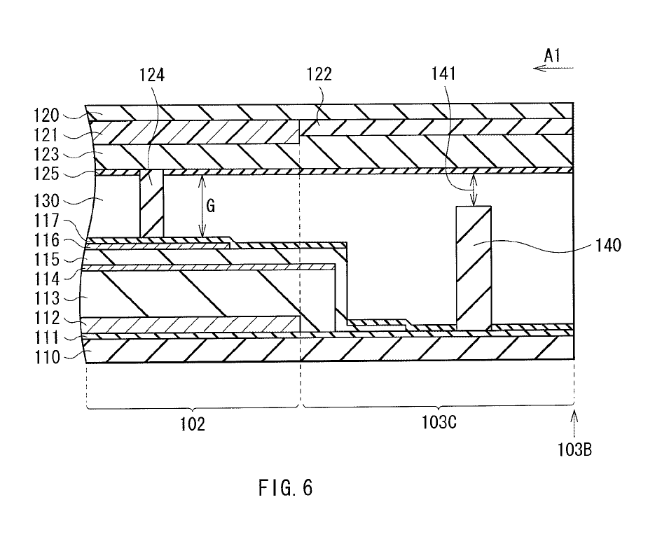

On the other hand, in the previous liquid crystal display device, a barrier 140 is provided in the vicinity of an injection port 103B as shown in FIG. 6. Therefore, at the time of injection of the sealing material, a clearance 141 is easily changed in size whenever the liquid crystal material and the sealing material flow therethrough. As a result, the injection speed of the sealing material greatly varies, thereby disadvantageously causing changes in the injection amount of the sealing material, i.e., sometimes too much but sometimes not enough. Moreover, the injection failure of the liquid crystal material occurs frequently. Note that, in FIG. 6, any component same as that in FIG. 3 is provided with the same reference numeral additionally with a first digit of 1.

In the liquid crystal display device 1, when light enters the display section 2 from a backlight unit (not shown), the light passes through a polarizing plate (not shown), and then passes through the liquid crystal layer 30 while being subjected to pixel-to-pixel modulation based on a video voltage applied between the first and second substrates 10 and 20. After passing through the liquid crystal layer 30, the light passes through the second substrate 20 including the color filter 21, thereby being extracted to the outside of the polarizing plate (not shown) as color display light.

In this example, the barrier structure 40 is in contact with both the first and second substrates 10 and 20, thereby reducing the leakage of the sealing material 50 to the display section 2, and controlling the injection amount of the liquid crystal material not to cause a shortage thereof. Accordingly, any possible display failure resulted therefrom is reduced.

As described above, in this embodiment, the injection port section 3C is provided with the barrier structure 40 that includes the clearances 41, and is in contact with both the first and second substrates 10 and 20. With the barrier structure 40 as such, variation of the injection speed, time, and amount of the sealing material 50 is allowed to be reduce, and any possible display failure or others resulted therefrom are also allowed to be reduced.

### Modification Example 1

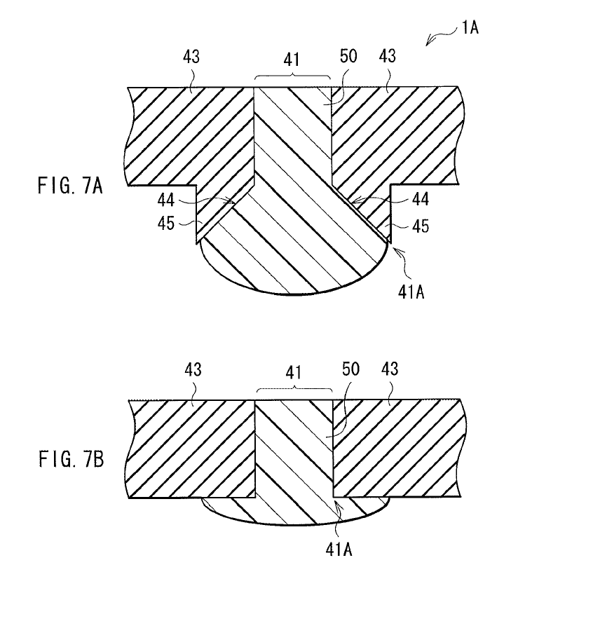

FIG. 7A is a diagram showing the configuration of the barrier structure 40 in a liquid crystal display device 1A in a modification example 1. This liquid crystal display device 1A includes a protrusion 45 with an inclined section 44 at the outlet 41A of the clearance 41. This is the only difference from the first embodiment, and the liquid crystal display device 1A has the configuration, functions, and effect similar to those thereof, and is manufactured similarly thereto.

The inclined section 44 is for stopping without fail the sealing material 50 at the outlet 41A of the clearance 41. As described in the first embodiment by referring to FIG. 5, the sealing material 50 stops moving at the outlet 41A of the clearance 41 between the pillars 43 due to the interfacial force. This interfacial force is dependent on the liquid crystal material, the sealing material 50, and the material of the barrier structure 40. Therefore, as exemplarily shown in FIG. 7B, when the outlet 41A of the clearance 41 is a flat surface, the sealing material 50 may slide down to around the outlet 41A of the clearance 41. Accordingly, by providing the inclined section 44 to the outlet 41A of the clearance 41, the sealing material 50 is received without fail at the inclined section 44.

Note that, as the configuration of the inclined section 44, as shown in FIG. 7A, the inclined section 44 may be formed to the protrusion 45 for provision at the outlet 41A of the clearance 41. Alternatively, the inclined section 44 may be configured by the inclined surface, which is formed naturally at the time of etching of the wall 42 or the pillars 43 during the manufacturing process of the barrier structure 40 (see FIG. 3).

### Modification Example 2

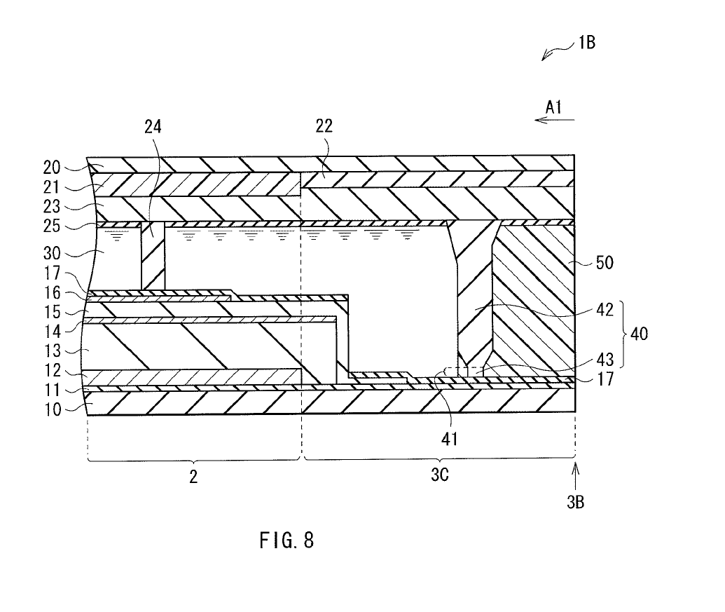

FIG. 8 is a diagram showing the configuration of the barrier structure 40 in a liquid crystal display device 1B according to a modification example 2. In this modification example, the pillars 43 are provided beneath the wall 42. This is the only difference from the first embodiment, and the liquid crystal display device 1B has the configuration, functions, and effect similar to those thereof, and is manufactured similarly thereto.

### Modification Example 3

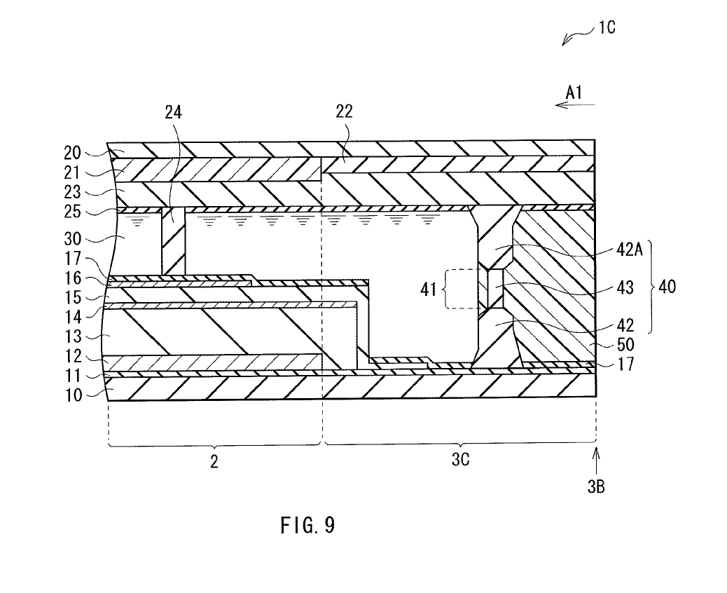

FIG. 9 is a diagram showing the configuration of the barrier structure 40 in a liquid crystal display device 1C according to a modification example 3. In this modification example, the pillars 43 are provided between upper and lower walls 42A and 42B. This is the only difference from the first embodiment, and the liquid crystal display device 1C has the configuration, functions, and effects similar to those thereof, and is manufactured similarly thereto.

(A) of FIG. 10 is a diagram showing the examination results of a difference of draw-in degree of the sealing material 50 between a case of providing the barrier structure 40 of FIG. 9 to the injection port section 3B (Example), and a case of not providing such a barrier structure 40 thereto (Comparative Example). (B) of FIG. 10 is a diagram showing the correlation between the lateral axis (draw-in position) of (A) of FIG. 10 and the position in the injection port section 3B. The draw-in position herein means the relative position when a position P40 of the barrier structure 40 is zero (0).

As shown in (A) and (B) of FIG. 10, when the barrier structure 40 is provided to the injection port section 3B, the sealing material 50 stops moving at the position of the barrier structure 40. On the other hand, when the barrier structure is not provided thereto, the draw-in degree of the sealing material 50 greatly varies, and the sealing material 50 is not partially drawn in enough, but is partially leaked all the way to the display section. This tells that if the injection port section 3C is provided with the barrier structure 40 having the clearances 41 and being in contact with both the first and second substrates 10 and 20, variation of the injection speed and amount of the sealing material 50 are allowed to be reduced.

### Modification Example 4

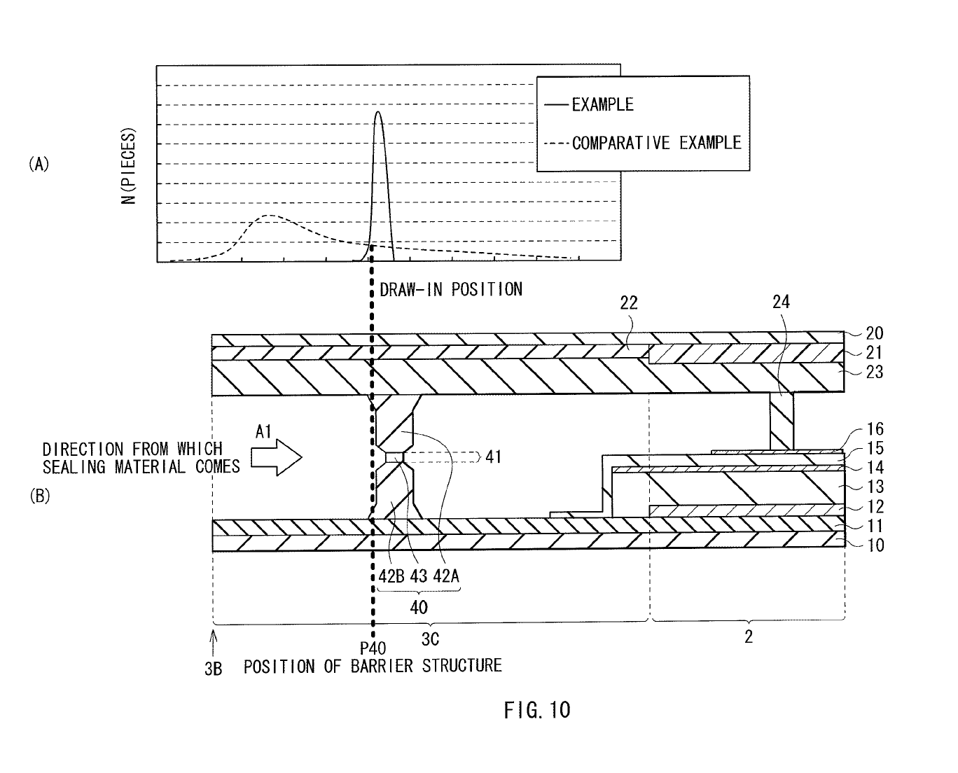

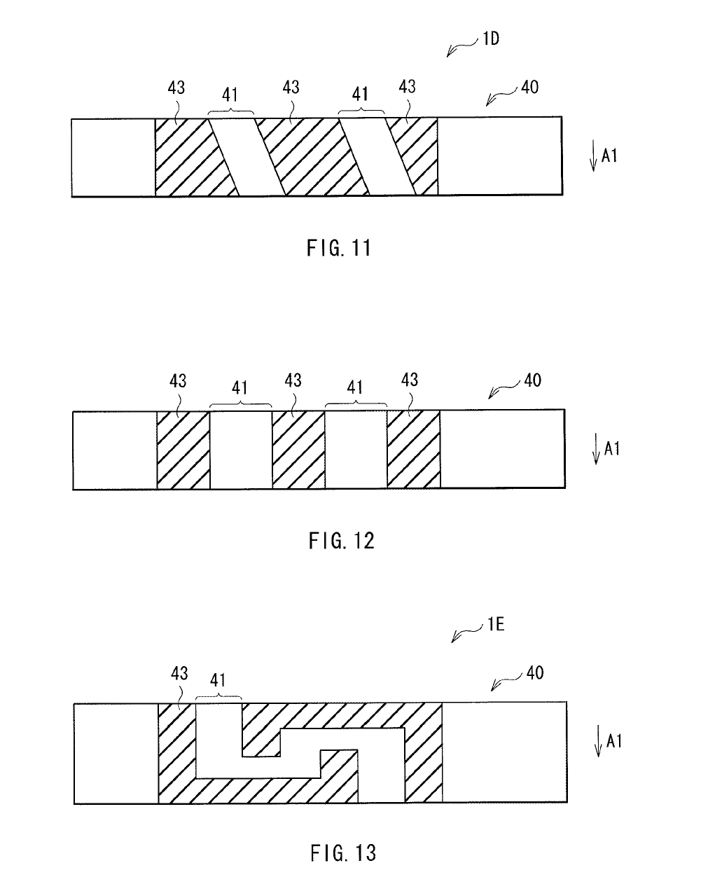

FIG. 11 is a diagram showing the configuration of the barrier structure 40 in a liquid crystal display device 1D according to a modification example 4. In this modification example, the clearances 41 are provided obliquely with respect to the direction A1 from which the sealing material 50 comes. With the liquid crystal display device 1D as such, the path for the sealing material 50 is lengthened compared with a case of providing the clearances 41 to be parallel to the direction from which the sealing material 50 comes as shown in FIG. 12 so that the effect of stopping the sealing material 50 is increased. This is the only difference from the first embodiment, and the liquid crystal display device 1D has the configuration, functions, and effects similar to those thereof, and is manufactured similarly thereto.

### Modification Example 5

FIG. 13 is a diagram showing the configuration of the barrier structure 40 in a liquid crystal display device 1E according to a modification example 5. In this modification example, the clearances 41 are each bent to be meandered. In the liquid crystal display device 1E as such, the path for the sealing material 50 is reduced in width but is increased in length so that the effect of stopping the sealing material 50 is increased. This is the only difference from the first embodiment, and the liquid crystal display device 1E has the configuration, functions, and effect similar to those thereof, and is manufactured similarly thereto.

### Modification Example 6

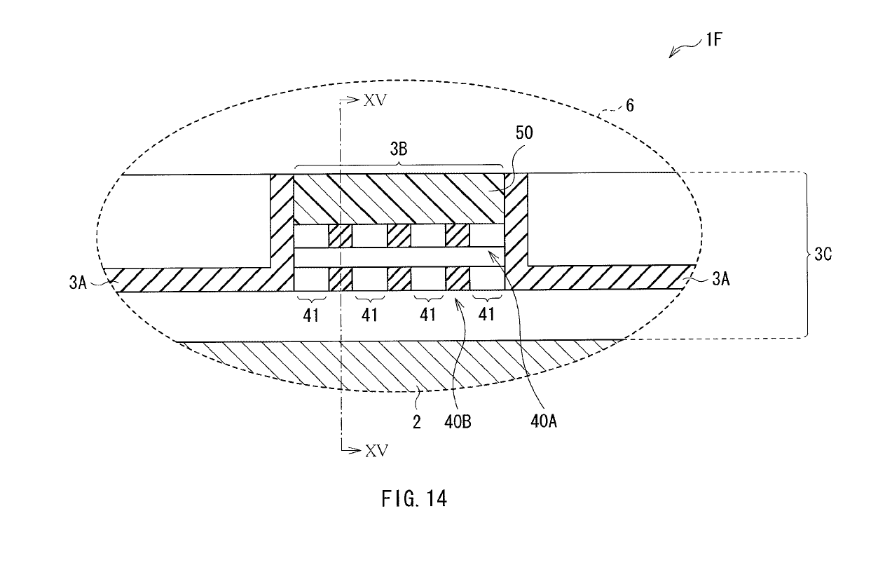

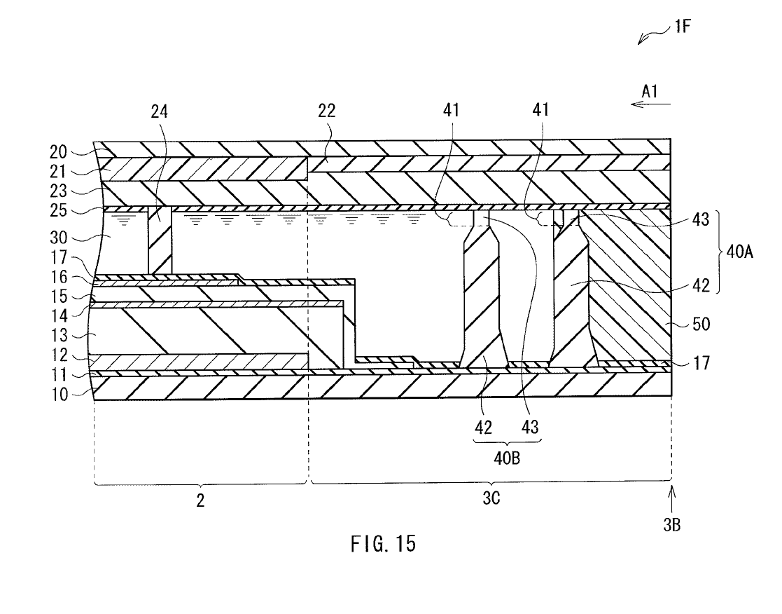

FIG. 14 is a diagram showing the configuration, in a planar view, of the injection port section 3C and therearound of the barrier structure 40 in a liquid crystal display device 1F according to a modification example 6. FIG. 15 shows the cross-sectional configuration of the injection port section 3C and therearound of FIG. 14 cut along a line XV-XV. In this modification example, a dual set of barrier structures 40A and 40B are respectively provided at two positions where the distances from the injection port 3B are different. With such a dual set of barrier structures 40A and 40B provided to the injection port section 3C, even if the outer barrier structure 40A allows the sealing material 50 to pass therethrough, the auxiliary inner barrier structure 40B stops the sealing material 50, thereby being able to stop without fail the leakage of the sealing material 50 to the display section 2. This is the only difference from the first embodiment, and the liquid crystal display device 1F has the configuration, functions, and effect similar to those thereof, and is manufactured similarly thereto.

### Modification Examples 7 to 13

In each of modification examples 7 to 13 below, the barrier structure 40 is configured by the same layer as any of the layers configuring the display section 2. Such a configuration allows the barrier structure 40 to be formed without increasing the number of processes.

### Modification Example 7

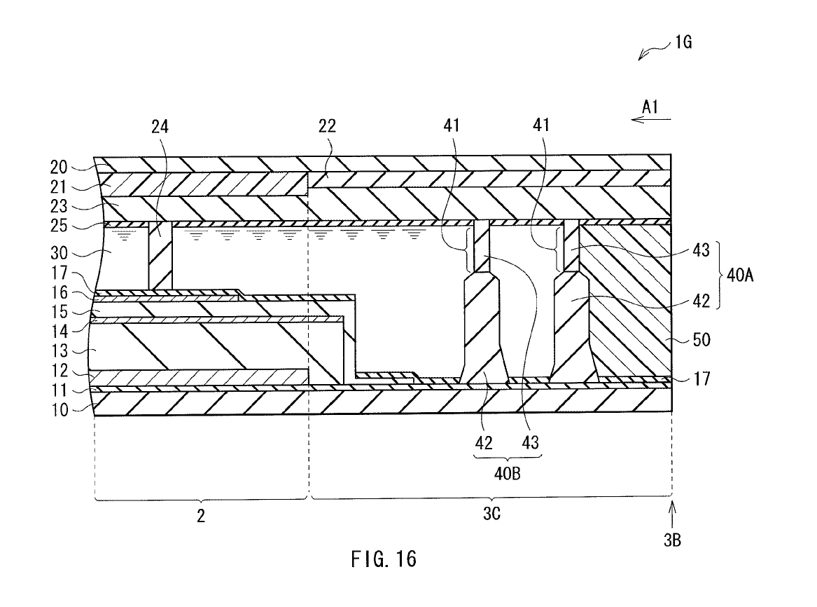

FIG. 16 is a diagram showing the cross-sectional configuration of the barrier structure 40 in a liquid crystal display device 1G according to the modification example 7. In this modification example, the pillars 43 are configured by the same layer as the spacer layer 24 of the display section 2. This is the only difference from the first embodiment, and the liquid crystal display device 1G has the configuration, functions, and effect similar to those thereof, and is manufactured similarly thereto.

### Modification Example 8

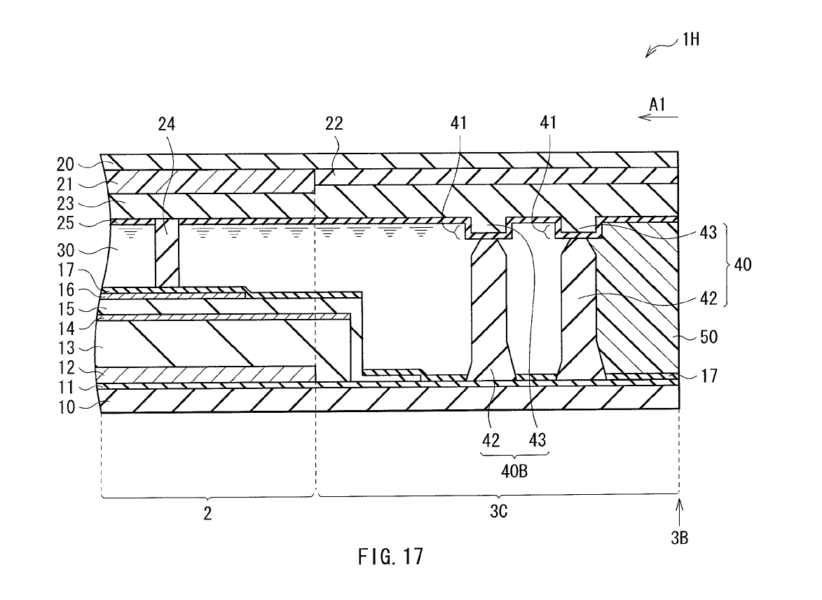

FIG. 17 is a diagram showing the cross-sectional configuration of the barrier structure 40 in a liquid crystal display device 1H according to the modification example 8. In this liquid crystal display device 1H in this modification example, the pillars 43 are configured by the same layer as the overcoat layer 23. This is the only difference from the first embodiment, and the liquid crystal display device 1H has the configuration, functions, and effects similar to those thereof, and is manufactured similarly thereto.

### Modification Example 9

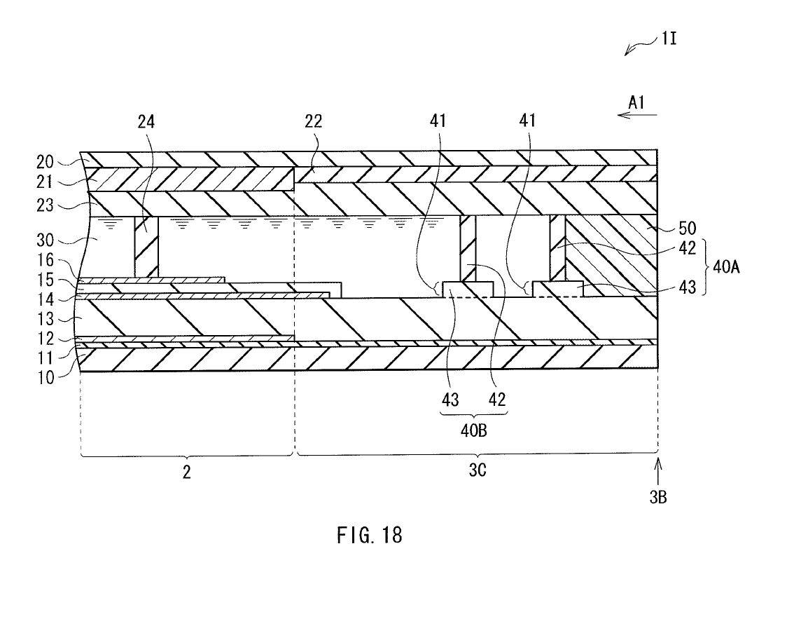

FIG. 18 is a diagram showing the cross-sectional configuration of the barrier structure 40 in a liquid crystal display device 1I according to the modification example 9.

FIG. 19 is a diagram showing the configuration of the barrier structure 40 of FIG. 18. In this modification example, the wall 42 is configured by the same layer as the spacer layer 24 of the display section 2, and the pillars 43 are configured by the same layer as the organic insulating layer 13. This is the only difference from the first embodiment, and the liquid crystal display device 1I has the configuration, functions, and effects similar to those thereof, and is manufactured similarly thereto.

The spacer layer 24 is generally configured by a negative resist, and thus is difficult to be precisely adjusted in height. Moreover, the height of the spacer layer 24 of the display section 2 is determined by the optical characteristics. On the other hand, the organic insulating layer 13 is configured by a positive resist. By exposure to light, the positive resist is controlled in thickness down to several hundred nm, and controlled in width down to several μm. Moreover, the positive resist allows the organic insulating layer 13 and the pillars 43 to be formed in the same process so that the possibility of any additional process and reduction of productivity is low. Moreover, using a half-tone mask that changes the height by changing the amount of light exposure, the organic insulating layer 13 and the pillars 43 may be formed in the same process and with the same photomask, thereby reducing more the process load.

### Modification Example 10

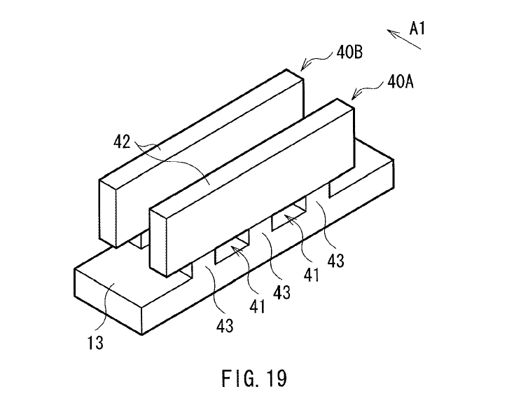

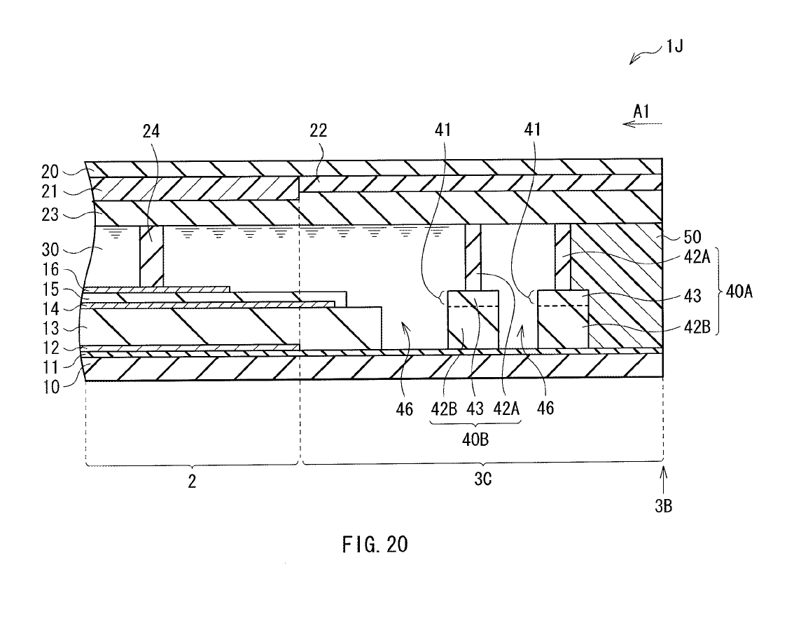

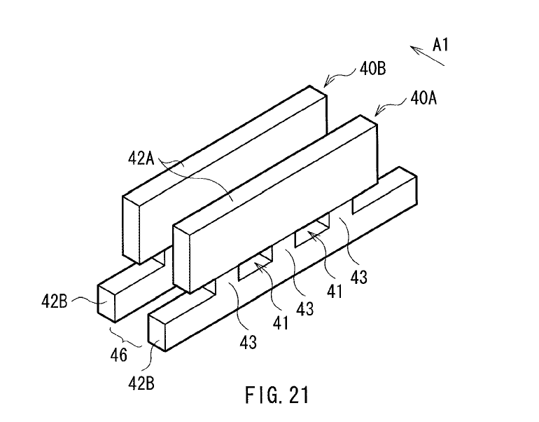

FIG. 20 is a diagram showing the cross-sectional configuration of the barrier structure 40 in a liquid crystal display device 1J according to the modification example 10. FIG. 21 is a diagram showing the configuration of the barrier structure 40 of FIG. 20. In this liquid crystal display device 1J, the organic insulating layer 13 around the barrier structure in the modification example 9 is removed to have a concave section 46. This is the only difference from the first embodiment, and the liquid crystal display device 1J has the configuration, functions, and effects similar to those thereof, and is manufactured similarly thereto.

The barrier structure 40 is provided with the pillars 43 between the upper and lower walls 42A and 42B similarly to the modification example 3. The upper wall 42A is formed by the same layer as the spacer layer 24 of the display section 2 similarly to the modification example 9. The lower wall 42B and the pillars 43 are configured by the same layer as the organic insulating layer 13.

The concave section 46 is provided around the lower wall 42B by the partial removal of the organic insulating layer 13 as described above. With the liquid crystal display device 1J as such, the sealing material 50 which has passed through the barrier structure 40 is captured and stored in the concave section 46. In other words, by using the concave section 46 as a portion for accumulation of the sealing material 50, the leakage of the sealing material 50 to the display section 2 is reduced without fail.

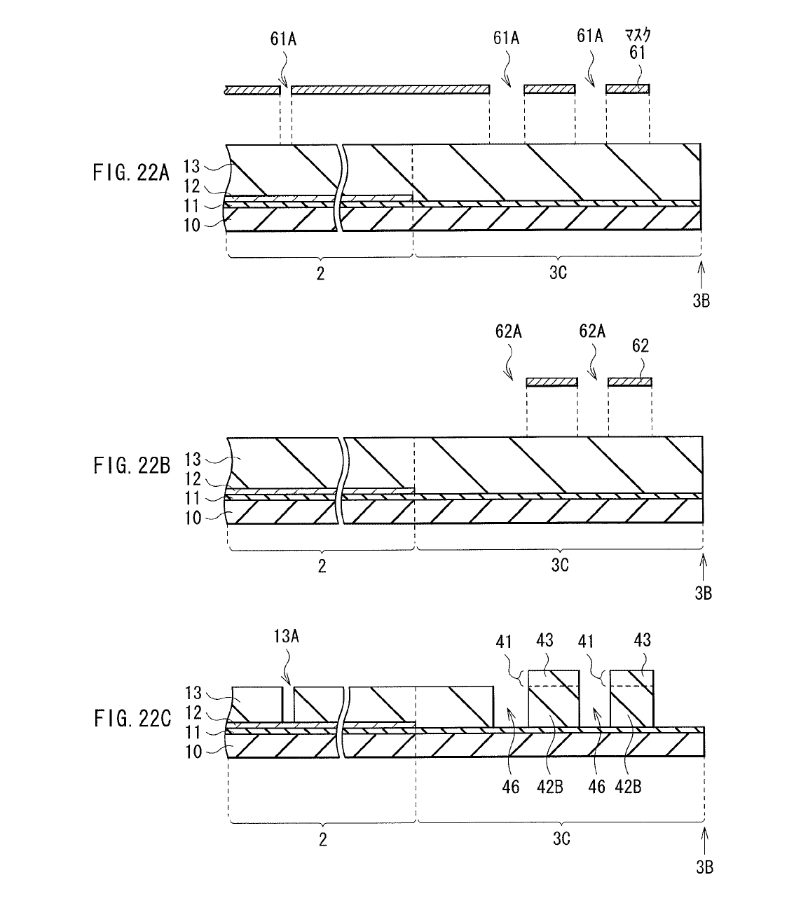

FIGS. 22A to 24B are diagrams showing, in order, the main part of a method of manufacturing the liquid crystal display device 1J of FIG. 20. First of all, as shown in FIG. 22A, the first substrate 10 made of glass or others is made ready, and a drive circuit (not shown) being a TFT or others, and the metal wiring layer 12 are formed on this first substrate 10.

Thereafter, also as shown in FIG. 22A, the organic insulating layer 13 is formed on the entire surface of the first substrate 10, and light is directed to a portion in the display section 2 at the position for forming a contact hole, and to a portion in the injection port section 3C at the position for forming the concave section 46. This is the light exposure for the first time, and is performed using a mask 61 provided with apertures 61A.

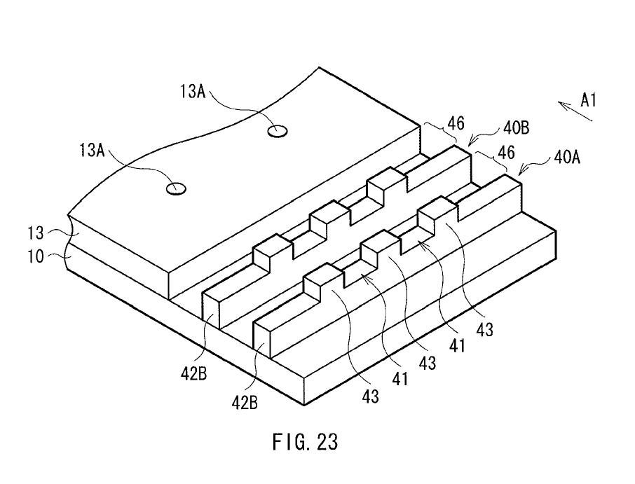

Thereafter, as shown in FIG. 22B, light is directed to a region for forming the display section 2, and to a portion in the injection port section 3C at the position for forming the clearance 41. This is the light exposure for the second time, and is performed using a mask 62 provided with apertures 62A. At this time, the region for forming the display section 2 and the position for forming the clearance 41 are exposed to the same amount of light. In this manner, as shown in FIGS. 22C and 23, the organic insulating layer 13 and a contact hole 13A are formed in the display section 2. The pillars 43 are formed in the injection port section 3C by the same layer as the organic insulating layer 13, and the clearance 41 is formed between each two of the pillars 43 (see FIG. 21). Thereafter, the organic insulating layer 13 around the pillars 13 is removed to form the lower wall 42B and the concave section 46.

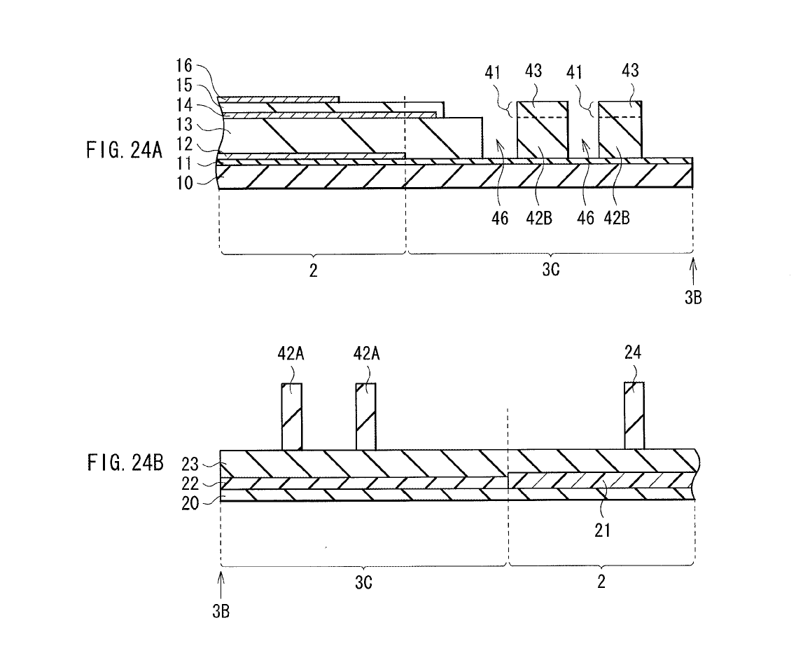

Thereafter, as shown in FIG. 24A, the common electrode 14, the inter-layer insulating film 15, and the pixel electrode 16 are formed in order on the organic insulating layer 13.

Moreover, as shown in FIG. 24B, the second substrate 20 made of glass or others is made ready, and the color filter 21 and the light-shielding film 22 are formed on this second substrate 20. Next, the color filter 21 and the light-shielding film 22 are coated by the overcoat layer 23, thereby planarizing the surface. Thereafter, the spacer layer 24 is formed in the display section 2, and using the layer same as the spacer layer 24, the upper wall 42A is formed.

Next, the orientation film 17 (not shown in FIG. 24A, and see FIG. 3) is formed to the display section 2 of the first substrate 10, and the sealing frame 3A is formed to the frame edge section 3 of the first substrate 10 using a thermosetting resin or an ultraviolet curable resin. The sealing frame 3A is formed in the rectangular shape to enclose the display section 2, and is provided with the injection port 3B on one side of the first substrate 10. Between the injection port 3B and the display section 2, the injection port section 3C is formed. Moreover, the orientation film 25 (not shown in FIG. 24B, and see FIG. 3) is formed to the display section 2 of the second substrate 20.

Thereafter, the first and second substrates 10 and 20 are opposed to each other with the sealing frame 3A sandwiched therebetween. The resin configuring the sealing frame 3A is then cured, thereby affixing together the first and second substrates 10 and 20. As a result, formed is the barrier structure 40 including the upper wall 42A configured by the same layer as the spacer layer 24, and the lower wall 42B and the pillars 43 configured by the same layer as the organic insulating layer 13.

Next, a liquid crystal material is filled into the internal space between the first and second substrates 10 and 20. The liquid crystal material is directed to the display section 2 after passing through the clearances 41 between the pillars 43 of the barrier structure 40.

Thereafter, under a reduced pressure inside the sealing frame 3A, the sealing material 50 is applied around the injection port 3B, thereby directing the sealing material 50 into the injection port section 3C to fill the portion from the injection port 3B to the barrier structure 40. In this manner, the liquid crystal display device 1J of FIG. 20 is completed.

### Modification Example 11

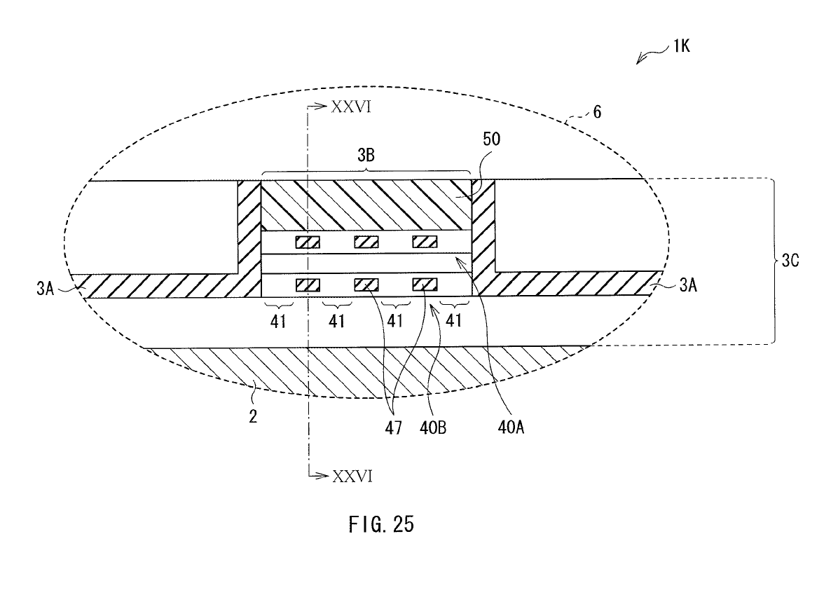

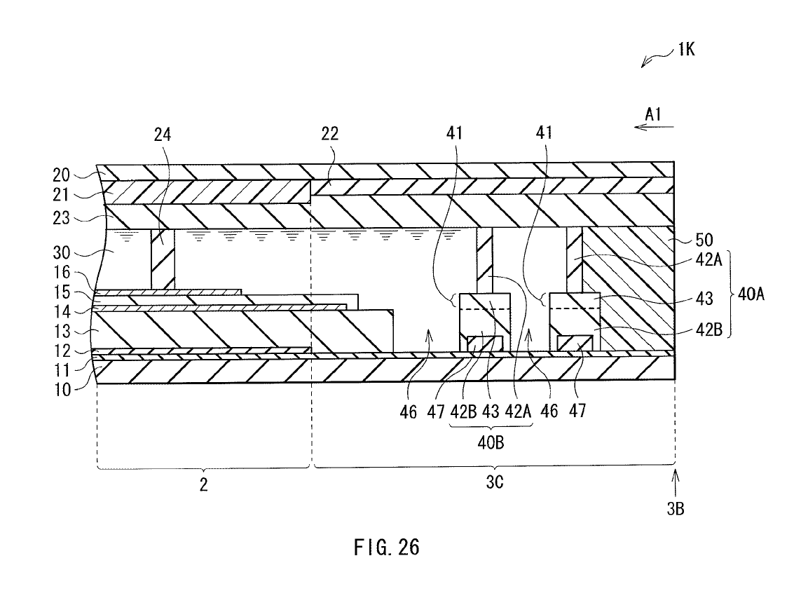

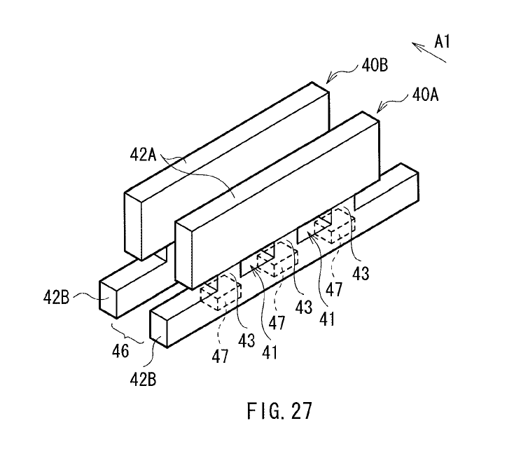

FIG. 25 is an enlarged view of a part of a liquid crystal display device 1K according to the modification example 11, and FIG. 26 is a diagram showing the cross-sectional configuration of the part of FIG. 25 cut along a line XXVI-XXVI. FIG. 27 is a diagram showing the configuration of the barrier structure 40 of FIG. 26. In this modification example, a base layer 47 is provided beneath the organic insulating layer 13 of the lower wall 42B to make uneven the surface of the organic insulating layer 13, and the resulting surface asperities serve as the pillars 43. This allows the omission of the patterning process to be executed to the pillars 43. This is the only difference from the first embodiment, and the liquid crystal display device 1K has the configuration, functions, and effects similar to those thereof, and is manufactured similarly thereto.

The base layer 47 is preferably configured by the same layer as the insulating layer 11 or as the metal wiring layer 12. With such a configuration, the pillars 43 are formed without increasing the number of photomasks and processes, thereby contributing to the increase of productivity. Specifically, since the metal wiring layer 12 is thick, by configuring the base layer 47 by the same layer as the metal wiring layer 12, the effects to be produced are much higher.

### Modification Example 12

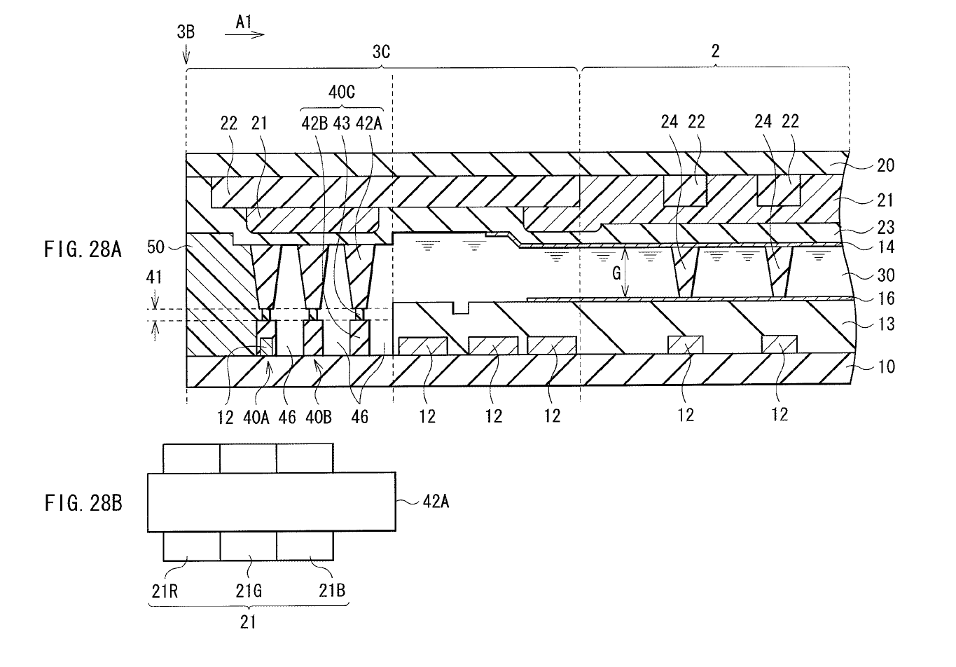

FIG. 28A is a diagram showing the cross-sectional configuration of the barrier structure 40 of a liquid crystal display device 1L according to the modification example 12. In this liquid crystal display device 1L, the cell gap G is adjusted using the existing layers such as the metal wiring layer 12, the color filter 21, and the light-shielding film 22. Among the modification examples 7 to 13, this modification example accordingly most enhances the effect of forming the barrier structure 40 without increasing the number of processes. This is the only difference from the first embodiment, and the liquid crystal display device 1L has the configuration, functions, and effects similar to those thereof, and is manufactured similarly thereto.

The display section 2 in this modification example is configured similarly to that in the first embodiment except that the pixel electrode 16 made of ITO (Indium Tin Oxide) or others is formed on the organic insulating layer 13 of the first substrate 10, and the common electrode 14 made of ITO or others is formed on the overcoat layer 23 of the second substrate 20.

Similarly to the modification example 6, for example, the injection port section 3C is provided with a triple set of barrier structures 40A, 40B, and 40C respectively at three positions where the distances from the injection port 3B are different. Such a triple set of barrier structures 40A, 40B, and 40C are all in the same configuration, and thus are collectively referred to as the barrier structure 40 in the below.

The barrier structure 40 is configured to have the multi-layer structure including the upper wall 42A configured by the same layers as the layers in the display section 2, i.e., the light-shielding film 22, the color filter 21, the overcoat layer 23, and the spacer layer 24, and the lower wall 42B and the pillars 43 configured by the same layer as the organic insulating layer 13. To be specific, the clearances 41 are located on the organic insulating layer 13 side. Around the lower wall 42B, similarly to the modification example 10, the concave section 46 is formed by the partial removal of the organic insulating layer 13.

The spacer layer 24 is generally configured by a negative resist, and thus is difficult to be adjusted in height. Moreover, the height of the spacer layer 24 of the display section 2 is determined by the optical characteristics. On the other hand, the organic insulating layer 13 is configured by a positive resist. By exposure to light, the positive resist is controlled in thickness down to several hundred nm, and controlled in width down to several μm. Moreover, the positive resist allows the organic insulating layer 13 and the pillars 43 to be formed in the same process so that the possibility of any additional process and reduction of productivity is low. Moreover, using a half-tone mask that changes the height by changing the amount of light exposure, the organic insulating layer 13 and the pillars 43 may be formed in the same process and with the same photomask, thereby reducing more the process load.

Also in this modification example, in the display section 2, the light-shielding film 22 is preferably overlaid on the spacer layer 24, and in the injection port section 3C, the color filter 21 is preferably overlaid on the upper wall 42A. When the metal wiring layer 12 is provided beneath the spacer layer 24 in the display section 2, the metal wiring layer 12 is preferably provided also beneath the organic insulating layer 13 of the lower wall 42B in the injection port section 3C. With the barrier structure 40 in the multi-layer structure as in the display section 2, the clearances 41 are to be controlled with ease.

In order to adjust the clearances 41 with precision, the total thickness of the layers in the display section 2, i.e., the light-shielding film 22, the color filter 21, the overcoat layer 23, and the spacer layer 24, is expected to be the same as the height of the upper wall 42A. In reality, however, the film thickness is expected to be adjusted later, and this causes a production load and variations. As an example, in the modification example 2 in which the pillars 43 are provided beneath the wall 42 as shown in FIG. 8, if the wall 42 is low in height, the configuration becomes similar to the previous configuration of FIG. 6. In consideration thereof, in this modification example, the upper wall 42A is configured to have the multi-layer structure configured by the same layers as those in the display section 2, i.e., the light-shielding film 22, the color filter 21, the overcoat layer 23, and the spacer layer 24, so that the clearances 41 are to be adjusted in the easiest manner, and the production load is to be reduced. Moreover, although the total thickness of the common electrode 14 and the pixel electrode 16 in the display section 2 is several hundred nm, the thickness of the color filter 21, the light-shielding film 22 (when it is made of resin), and the overcoat layer 23 is thick such as several μm order. Therefore, by configuring the upper wall 42A by the same layers as those in the display section 2, i.e., the light-shielding film 22, the color filter 21, the overcoat layer 23, and the spacer layer 24, the upper wall 42A remains high, and the performance of the resulting barrier structure 40 is enhanced.

In particular, generally, the color filter 21 is not provided to the frame edge section 3 but is provided beneath the spacer layer 24 of the display section 2. Therefore, when the upper wall 42A is configured by the same layer as the spacer layer 24, as shown in FIG. 28B, on the upper wall 42B, a red filter 21R, a green filter 21G, and a blue filter 21B are preferably arranged in the in-plane direction similarly to inside of the display section 2.

This is the only difference from the first embodiment, and the liquid crystal display device 1L has the configuration, functions, and effects similar to those thereof, and is manufactured similarly thereto.

### Modification Example 13

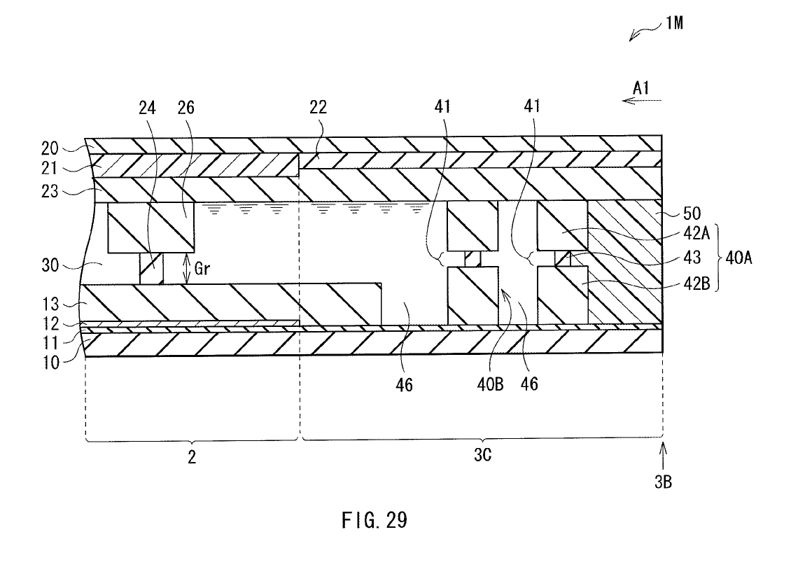

FIG. 29 is a diagram showing the cross-sectional configuration of the barrier structure 40 in a liquid crystal display device 1M according to the modification example 13. In the liquid crystal display device 1M, similarly to the modification example 3, the barrier structure 40 includes the pillars 43 between the upper and lower walls 42A and 42B. Herein, the liquid crystal display device 1M is a semi-transmissive liquid crystal display device in the ECB (Electrically Controlled Birefringence) mode. The liquid crystal display device 1M includes the pixel electrode (not shown) on the organic insulating layer 13 of the first substrate 10, and the common electrode (not shown) on the overcoat layer 23 of the second substrate 20. Also in the semi-transmissive liquid crystal display device 1M, a gap adjusting layer 26 is provided to the reflection section with the aim of adjusting a difference of cell gap G between the transmission section and the reflection section. The liquid crystal display device 1M may be in the vertical alignment mode.

The upper wall 42A is configured by the same layer as the gap adjusting layer 26 of the semi-transmissive display section 2. The pillars 43 are configured by the same layer as the spacer layer 24. The lower wall 42B is configured by the same layer as the organic insulating layer 13. The semi-transmissive reflection section is provided with, as a film-thickness-adjustable layer (layer available for diverting use in the barrier structure 40), the gap adjusting layer 26 is also provided in addition to the spacer layer 24 and the organic insulating layer 13, which are also provided to the transmissive liquid crystal display device. Accordingly, the barrier structure 40 is allowed to be formed easily without increasing the number of processes.

The narrower width of the clearance 41 produces a higher effect, and the width thereof is desirably in the range of about 0.5 μm to 1 μm. On the other hand, the gap Gr of the reflection section is dependent on the optical characteristics, and does not generally fall in the range of 0.5 μm to 1 μm, i.e., larger. Therefore, the lower wall 42B is higher than the multi-layer structure including the organic insulating layer 13 and the pixel electrode (not shown) of the display section 2, and the clearance 41 is narrower than the gap Gr of the reflection section.

This liquid crystal display device is manufactured as below, for example.

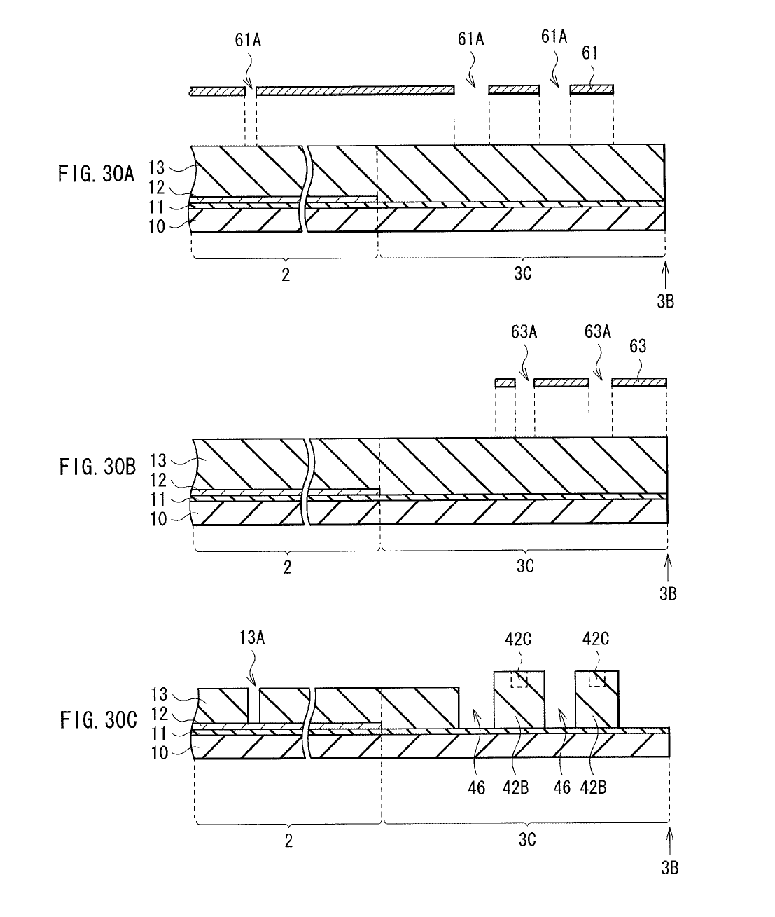

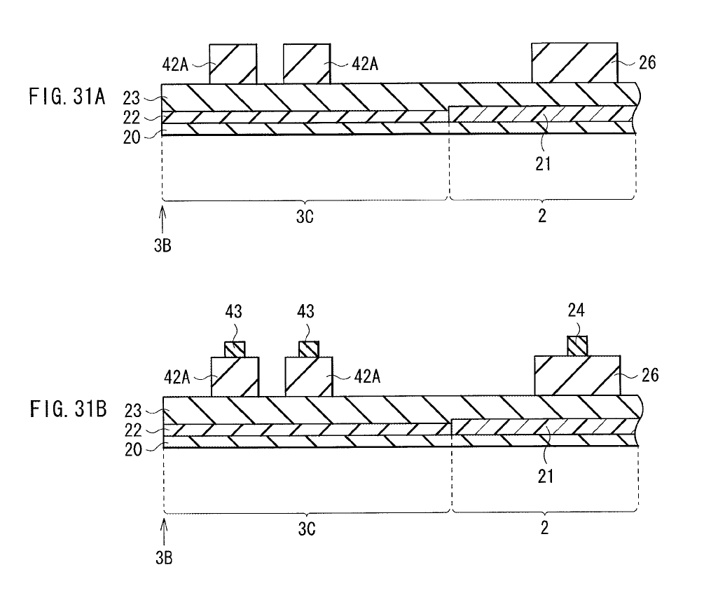

FIGS. 30A to 31B are diagrams showing, in order, the main part of the method of manufacturing the liquid crystal display device 1M of FIG. 29. With this manufacturing method, a size difference between the gap Gr of the reflection section of the display section 2 and the clearance 41 of the barrier structure 40 is adjusted by changing the thickness of the organic insulating layer 13. Note that any part where the manufacturing process is the same as that in the modification example 10 is described by referring to FIGS. 22A to 22C, and 24A and 24B.

First of all, as shown in FIG. 30A, similarly to the modification example 10, the first substrate 10 made of glass or others is made ready by the process of FIG. 22A, and the drive circuit (not shown) being a TFT or others, and the metal wiring layer 12 are formed on this first substrate 10.

Thereafter, also as shown in FIG. 30A, similarly to the modification example 10, the organic insulating layer 13 is formed on the first substrate 10, and light is directed to a portion in the display section 2 at the position for forming a contact hole, and to a portion in the injection port section 3C at the position for forming the concave section 46 by the process of FIG. 22A. This is the light exposure for the first time, and is performed using the mask 61 provided with the apertures 61A.

Thereafter, as shown in FIG. 30B, light is directed to a region for forming the display section 2, and to a part of a region for forming the lower wall 42B. This is the light exposure for the second time, and is performed using a mask 63 provided with apertures 63A. In this manner, as shown in FIG. 30C, the organic insulating layer 13 and the contact hole 13A are formed in the display section 2, and the lower wall 42B is formed by the same layer as the organic insulating layer 13. At the same time, a concave section 42C is partially formed on the upper surface of the lower wall 42B.

Thereafter, on the organic insulating layer 13, the transmission section forms the pixel electrode (not shown) by a transparent electrode made of ITO or others, and the reflection section forms the pixel electrode (not shown) using a light-reflecting electrode made of aluminum (Al) or silver (Ag), for example. Thereafter, the orientation film (not shown) is formed on the pixel electrode.

Moreover, as shown in FIG. 31A, the second substrate 20 made of glass or others is made ready, and the color filter 21 and the light-shielding film 22 are formed on this second substrate 20. Next, the color filter 21 and the light-shielding film 22 are coated by the overcoat layer 23, thereby planarizing the surface. Thereafter, on the overcoat layer 23, the common electrode (not shown) is formed.

Thereafter, also as shown in FIG. 31A, the gap adjusting layer 26 is formed in the reflection section of the display section 2, and the upper wall 42A is formed by the same layer as the gap adjusting layer 26.

Next, as shown in FIG. 31B, the spacer layer 24 is formed in the display section 2, and the pillars 43 are formed by the same layer as the spacer layer 24. The spacer layer 24 and the pillars 43 are formed to have the same height. Thereafter, the orientation film (not shown) is formed.

After the formation of the first and second substrates 10 and 20 as such, to the frame edge section 3 of the first substrate 10, for example, the sealing frame 3A is formed by a thermosetting resin or an ultraviolet curable resin. The sealing frame 3A is formed in the rectangular shape to enclose the display section 2, and is provided with the injection port 3B on one side of the first substrate 10. Between the injection port 3B and the display section 2, the injection port section 3C is formed.

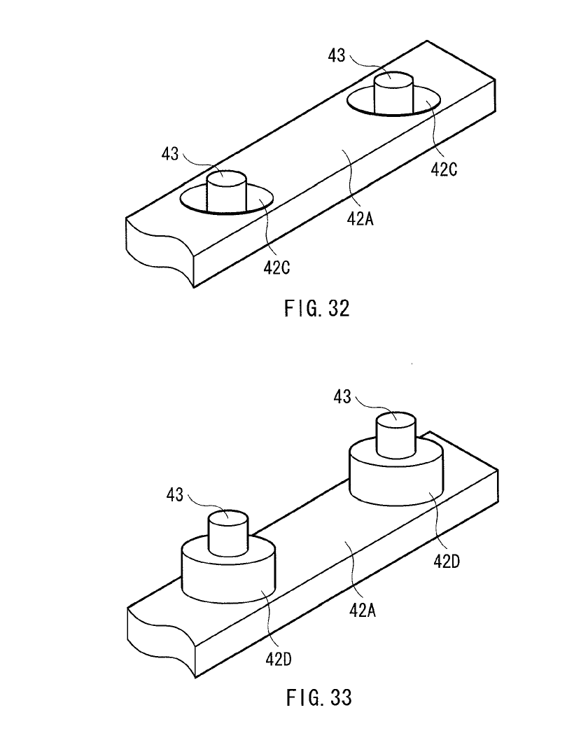

Thereafter, the first and second substrates 10 and 20 are opposed to each other with the sealing frame 3A sandwiched therebetween. The resin configuring the sealing frame 3A is then cured, thereby affixing together the first and second substrates 10 and 20. As a result, formed is the barrier structure 40 including the upper wall 42A configured by the same layer as the gap adjusting layer 26, the lower wall 42B configured by the same layer as the organic insulating layer 13, and the pillars 43 configured by the same layer as the spacer layer 24. As shown in FIG. 32, the tip end portion of each of the pillars 43 are accommodated in the concave section 42C of the lower wall 42B. Accordingly, the clearances 41 are reduced in size to be smaller than the gap Gr of the reflection section of the display section 2 (the height of the spacer layer 24, i.e., the height of the pillars 43).

Adjusting the size of the clearances 41 by the patterning of the organic insulating layer 13 as such has the following advantages. The spacer layer 24 is generally configured by a negative resist, and thus the height adjustment of the pillars 43 configured by the same layer as the spacer layer 24 is difficult. Moreover, the height of the spacer layer 24 of the display section 2 is dependent on the design of the cell gap G of the display section 2 and the optical characteristics. On the other hand, the organic insulating layer 13 is configured by a positive resist. By exposure to light, the positive resist is controlled in thickness down to several hundred nm, and controlled in width down to several μm. Therefore, only by changing the mask type of the organic insulating layer 13, the clearances 41 are to be adjusted by size. Moreover, since the gap Gr of the reflection section is expected to be narrow, this affects little the productivity.

Contrary to the case of FIG. 32, when the clearance 41 is to be larger than the gap Gr of the reflection section of the display section 2 (the height of the spacer layer 24, i.e., the height of the pillars 43), as shown in FIG. 33, the lower wall 42B configured by the same layer as the organic insulating layer 13 is provided with a base section 42D for placement of the tip end portions of the pillars 43. For the purpose, at the time of the light exposure for the second time shown in FIG. 30B, the portion not being the base section 42D of the lower wall 42 is exposed to light in the same amount as that to the region where the display section 2 is to be formed.

After the first and second substrates 10 and 20 are affixed together as such, the liquid crystal material is injected into the internal space between the first and second substrates 10 and 20. The liquid crystal material is directed to the display section 2 after passing through the clearances 41 between the pillars 43 in the barrier structure 40.

Thereafter, under a reduced pressure inside the sealing frame 3A, the sealing material 50 is applied around the injection port 3B, thereby directing the sealing material 50 into the injection port section 3C to fill the portion from the injection port 3B to the barrier structure 40. As such, the liquid crystal display device 1M of FIG. 29 is completed.

### Second Embodiment

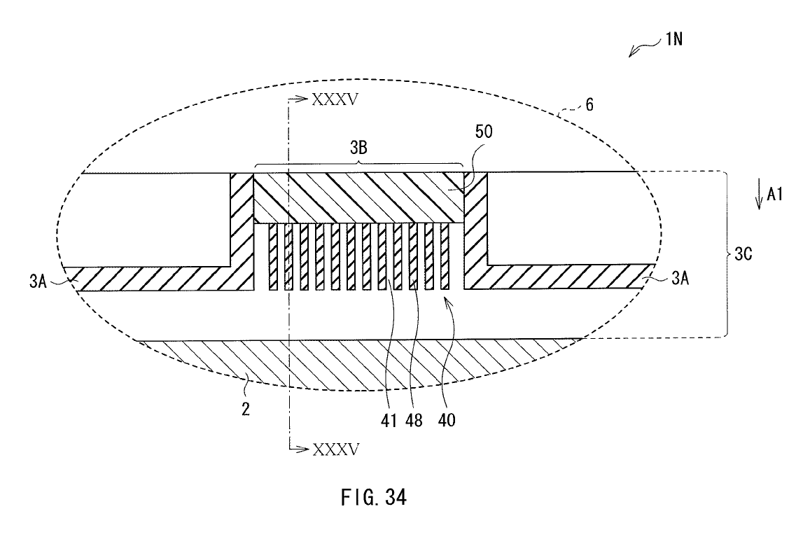

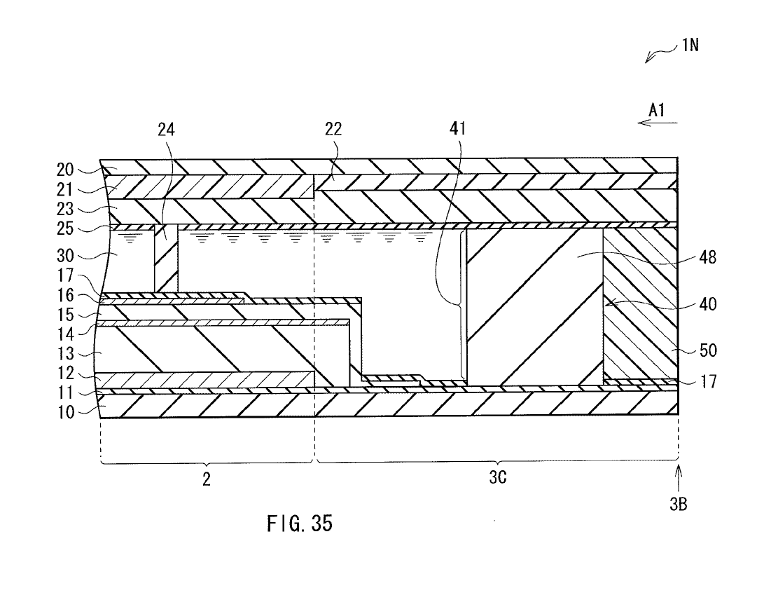

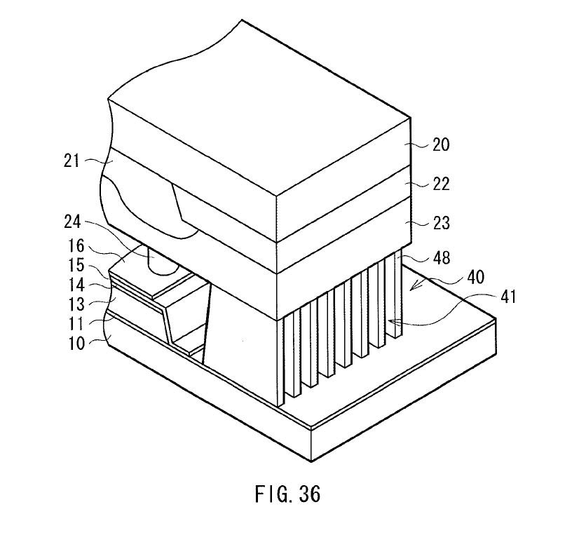

FIG. 34 is an enlarged view of a part of a liquid crystal display device 1N according to a second embodiment of the present disclosure, and FIG. 35 is a diagram showing the cross-sectional configuration of the part of FIG. 34 cut along a line XXXV-XXXV. FIG. 36 is a diagram showing the configuration of the barrier structure of FIG. 35. In this liquid crystal display device 1N, similarly to the first embodiment, the injection port section 3B is provided with the barrier structure 40 and the sealing material 50. Similarly to the first embodiment, the barrier structure 40 has the clearances 41 to allow the liquid crystal material to pass therethrough, and is in contact with both the first and second substrates 10 and 20. To be specific, the barrier structure 40 has a plurality of walls 48 between the first and second substrates 10 and 20. The walls 48 are provided in the direction not vertical (for example, parallel) to the direction A1 from which the sealing material 50 comes. With the liquid crystal display device 1N as such, similarly to the first embodiment, variation of the injection speed and amount of the sealing material 50 is allowed to be reduced.

For example, the walls 48 are provided in the direction parallel to the direction A1 from which the sealing material 50 comes, and are disposed with the clearance 41 between each two thereof. The liquid crystal material is directed to the display section 2 after passing through the clearances 41 between the walls 48. By adjusting the width of the clearances 41, the speed and amount of injection of the sealing material 50 are controlled similarly to the wall 42 in the first embodiment. The clearances 41 between the walls 48 may be provided obliquely with respect to the direction A1 from which the sealing material 50 comes as in the modification example 4, or as in the modification example 5, may be bent to be meandered. The walls 48 may be configured by the same layer as the spacer layer 24 or as the overcoat layer 23.

This is the only difference from the first embodiment, and the liquid crystal display device 1N has the configuration, functions, and effects similar to those thereof, and is manufactured similarly thereto.

### Modification Example 14

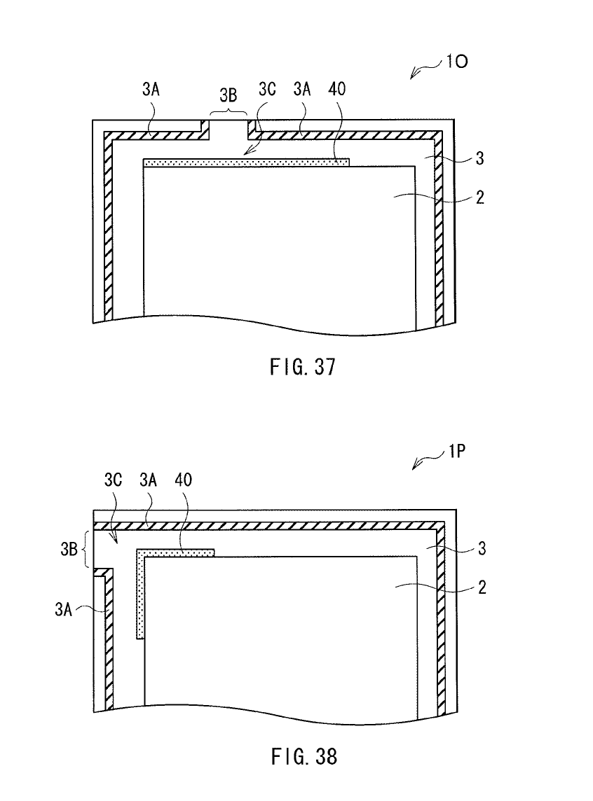

FIG. 37 is a diagram showing the configuration, in a planar view, of the barrier structure 40 in a liquid crystal display device 1O according to a modification example 14. The barrier structure 40 is for controlling the path for injection of the sealing material 50 to reduce the influence of the sealing material 50 over the display section 2. Therefore, as in this modification example, the injection port 3B may be provided at the middle position of one side of the display section 2, and the barrier structure 40 may be provided linearly along the contour of the display section 2. This is the only difference from the first or second embodiment, and the liquid crystal display device 1O has the configuration, functions, and effects similar to those thereof, and is manufactured similarly thereto.

### Modification Example 15

FIG. 38 is a diagram showing the configuration, in a planar view, of the barrier structure 40 in a liquid crystal display device 1P according to a modification example 15. In this modification example, the injection port 3B is provided at one corner of the display section 2, and the barrier structure 40 is provided in the L shape along the contour of the display section 2. This is the only difference from the modification example 14.

While the present disclosure has been described in detail by referring to the embodiments, the present disclosure is not restrictive to the embodiments described above, and numerous other modifications may be possibly devised. For example, in the first embodiment described above, exemplified is the case where the wall 42 or the upper and lower walls 42A and 42B are extended in the direction vertical to the direction A1 from which the sealing material 50 comes. Alternatively, the wall 42 or the upper and lower walls 42A and 42B may be extended in the direction substantially vertical to or intersecting with (oblique) the direction A1 from which the sealing material 50 comes.

Further, in the second embodiment described above, exemplified is the case where the walls 48 are provided in the direction parallel to the direction A1 from which the sealing material 50 comes. Alternatively, the walls 48 may be provided in the direction substantially vertical to or intersecting with (oblique) the direction A1 from which the sealing material 50 comes.

Still further, in the embodiments described above, exemplified is the case where the display section 2 is in the FFS configuration. Alternatively, the display section 2 may be in any other configurations such as TN (Twisted Nematic) or VA (Vertical Aligned).

Still further, for example, the materials and the thicknesses of the layers, the film-forming methods and condition, and others described in the embodiments above are not restrictive, and any other materials and thicknesses, or any other film-forming methods and condition are also applicable. For example, other than being made of glass, the first and second substrates 10 and 20 may be each made of silicon (Si), plastic, or any other materials with which the surface thereof remains insulative.

Still further, although exemplified in the embodiments above is the specific configuration of the liquid crystal display device, all of the components are not expected to be included, and any other components may be also included.

Still further, the display device of the present disclosure is applicable to a mobile phone, a smartphone, a digital camera, a portable DVD (Digital Versatile Disk) Blu-Ray viewer, a monitor of mobile equipment such as a portable game machine or of AV equipment, or a car navigation device, a photoframe, a small-sized notebook personal computer, or others. Among all, if the display device of the present disclosure is applied to the mobile phone or the smartphone, for example, it is advantageous in view of a reduced frame edge.

The present technology is also possibly in the following structures.

(1) A liquid crystal display device, including:

a display section including a liquid crystal layer between a pair of substrates; and

a frame edge section provided to a periphery section of the pair of substrates, wherein

the frame edge section includes an injection port and an injection port section, the injection port being for injection of a liquid crystal material, and the injection port section being provided between the injection port and the display section, and

the injection port section includes
a barrier structure including a clearance, and the barrier structure being in contact with both of the pair of substrates, and
a sealing material filled in a portion extending from the injection port to the barrier structure.

(2) The liquid crystal display device according to (1), wherein

the barrier structure includes
a wall provided to one or both of the pair of substrates, and the wall extending in a direction intersecting with a direction from which the sealing material comes, and
a plurality of pillars provided on the wall.

(3) The liquid crystal display device according to (2), further including

an inclined section at an outlet of the clearance.

(4) The liquid crystal display device according to (2) or (3), wherein

the barrier structure is provided at two or more positions where distances from the injection port are different.

(5) The liquid crystal display device according to (1), wherein

the barrier structure has a plurality of walls between the pair of substrates in a direction not vertical to a direction from which the sealing material comes.

(6) The liquid crystal display device according to any one of (1) to (5), wherein

the barrier structure is configured by a layer the same as other layers configuring the display section.

(7) A method of manufacturing a liquid crystal display device, the liquid crystal display device including a display section including a liquid crystal layer between a pair of substrates, and a frame edge section provided to a periphery section of the pair of substrates, and the frame edge section including an injection port and an injection port section, the injection port being for injection of a liquid crystal material, and the injection port section being provided between the injection port and the display section,

the method including:
forming a barrier structure to the injection port section, and the barrier structure including a clearance and being in contact with both of the pair of substrates; and
filling a sealing material in a portion extending from the injection port to the barrier structure.

(8) The method according to (7), wherein

the barrier structure is formed at the same time as other layers configuring the display section.

(9) The method according to (8), wherein

the barrier structure is formed in a multi-layer structure including a plurality of layers, and the plurality of layers are allocated to both of the pair of substrates.

(10) The method according to (8), wherein

the barrier structure is entirely provided to either one of the pair of substrates.

The present disclosure contains subject matter related to that disclosed in Japanese Priority Patent Application JP 2011-178210 filed in the Japan Patent Office on Aug. 17, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device, comprising:
a display section including a liquid crystal layer between a pair of substrates; and
a frame edge section provided to a periphery section of the pair of substrates, wherein
the frame edge section includes an injection port and an injection port section, the injection port being for injection of a liquid crystal material, and the injection port section being provided between the injection port and the display section, and
the injection port section includes
a barrier structure including a clearance, and the barrier structure being in contact with both of the pair of substrates, and
a sealing material filled in a portion extending from the injection port to the barrier structure.

2. The liquid crystal display device according to claim 1, wherein
the barrier structure includes
a wall provided to one or both of the pair of substrates, and the wall extending in a direction intersecting with a direction from which the sealing material comes, and
a plurality of pillars provided on the wall.

3. The liquid crystal display device according to claim 2, further comprising
an inclined section at an outlet of the clearance.

4. The liquid crystal display device according to claim 2, wherein
the barrier structure is provided at two or more positions where distances from the injection port are different.

5. The liquid crystal display device according to claim 1, wherein
the barrier structure has a plurality of walls between the pair of substrates in a direction not vertical to a direction from which the sealing material comes.

6. The liquid crystal display device according to claim 1, wherein
the barrier structure is configured by a layer the same as other layers configuring the display section.

7. A method of manufacturing a liquid crystal display device, the liquid crystal display device including a display section including a liquid crystal layer between a pair of substrates, and a frame edge section provided to a periphery section of the pair of substrates, and the frame edge section including an injection port and an injection port section, the injection port being for injection of a liquid crystal material, and the injection port section being provided between the injection port and the display section,
the method comprising:
forming a barrier structure to the injection port section, and the barrier structure including a clearance and being in contact with both of the pair of substrates; and
filling a sealing material in a portion extending from the injection port to the barrier structure.

8. The method according to claim 7, wherein
the barrier structure is formed at the same time as other layers configuring the display section.

9. The method according to claim 8, wherein
the barrier structure is formed in a multi-layer structure including a plurality of layers, and the plurality of layers are allocated to both of the pair of substrates.

10. The method according to claim 8, wherein
the barrier structure is entirely provided to either one of the pair of substrates.
